(19) United States
(12) Patent Application Publication
(10) Pub. No.: US 2018/0221978 A1
(43) Pub. Date: Aug. 9, 2018

(54) SOLDERING METHOD, SOLDERING APPARATUS, AND METHOD FOR MAINTAINING SOLDER WETTING OF JET NOZZLE

(71) Applicant: FUJITSU LIMITED, Kawasaki-shi (JP)

(72) Inventor: Toru Okada, Yokohama (JP)

(73) Assignee: FUJITSU LIMITED, Kawasaki-shi (JP)

(21) Appl. No.: 15/885,876

(22) Filed: Feb. 1, 2018

(30) Foreign Application Priority Data
Feb. 7, 2017 (JP) 2017-020451

(51) Int. Cl. B23K 3/06; B23K 3/08; B23K 35/26; C22C 13/00

(52) U.S. Cl. CPC B23K 3/0607; C22C 13/00; B23K 35/262; B23K 3/085

(57) ABSTRACT

A soldering method includes intermittently ejecting a solder jet to a workpiece from a jet nozzle, and spraying gas on an outer side surface of the jet nozzle when stopping ejection of the solder jet from the jet nozzle. And a soldering apparatus includes a first nozzle from which a solder jet is intermittently ejected to a workpiece, and a second nozzle from which gas is sprayed on an outer side surface of the first nozzle.

### CROSS-REFERENCE TO RELATED APPLICATION

This application is based upon and claims the benefit of priority of the prior Japanese Patent Application No. 2017-20451, filed on Feb. 7, 2017, the entire contents of which are incorporated herein by reference.

### FIELD

The embodiments discussed herein are related to a soldering method, a soldering apparatus, and a method for maintaining solder wetting of a jet nozzle.

### BACKGROUND

Today, soldering in the manufacture of printed circuit board assemblies involves bringing molten solder into contact with pins of electronic components inserted in through-holes to solder the pins of the electronic component to the through-holes.

For printed circuit board assemblies having many through-holes, a flow dip method is often used as a soldering method.

The flow dip method involves forming a molten solder jet over the width of a board assembly and bringing parts targeted for soldering into contact with the solder jet such that the parts pass through the solder jet, whereby these parts undergo soldering at the same time. This method has an issue of consumption of large amounts of solder, which causes oxidation (slagging) of large amounts of solder. Larger amounts of solder consumed results in larger amounts of solder waste.

The advance of surface mount technology for mounting electronic components on single and double-sided boards reduces the number of components to be mounted by the flow dip method.

For example, in printed circuit board assemblies for vehicles, connectors for external connection are targeted for soldering. Using the flow dip method in performing soldering on such particular parts leads to attachment of a solder jet to unintended parts or waste of large amounts of solder.

Thus, a soldering method using a local jet nozzle is developed.

The soldering method using a local jet nozzle involves scanning a solder jet only over parts targeted for soldering, which enables soldering on particular parts. Since this method uses a jet of about 4 mm from the tip of a local nozzle (Ø about 14 mm), the amount of solder consumed is as small as about a tenth of the amount of solder consumed in the case of generating a solder jet that ranges over the board width. In this method, only a small amount of solder waste is thus produced by oxidation.

High-quality soldering at a high speed using a local jet nozzle is achieved by good solder wetting on the outer side surface of the local jet nozzle. This is because solder wetting on the outer side surface of the local jet nozzle is expected to stabilize the shape of a solder jet and to cause the solder jet to be pulled down. The solder jet is pulled down due to the self-weight of solder moving along the outer side surface of the local jet nozzle, whereby solder is favorably drawn away from workpieces (board, pin). When solder wetting is poor on the outer side surface of the local jet nozzle, the solder is attached to other components due to a solder jet with an uneven shape and a short circuit occurs between pins due to a failure of drawing of the solder.

In the method using a local jet nozzle, a solder jet is not constantly ejected from the jet nozzle, and a solder jet is normally ejected for a certain period of time and ejection is then stopped for a certain period of time. Such a cycle is repeated during soldering. When ejection is stopped, solder wettability on the outer side surface of the jet nozzle deteriorates.

Here, a method for determining solder wettability on the outer side surface of the jet nozzle is developed. In this method, defects associated with poor solder wetting can be reduced by determining solder wettability.

This developed technique, however, fails to reduce poor solder wetting itself. If poor solder wetting occurs, nozzle cleaning is performed with a flux or the like to recover solder wettability. The operation for recovering solder wettability worsens the soldering efficiency because this operation is carried out after soldering has stopped.

The following is a reference document.
[Document 1] Japanese Laid-open Patent Publication No. 2016-221555.

### SUMMARY

According to an aspect of the invention, a soldering method includes intermittently ejecting a solder jet to a workpiece from a jet nozzle, and spraying gas on an outer side surface of the jet nozzle when stopping ejection of the solder jet from the jet nozzle.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram depicting poor wetting of solder on the outer side surface of a jet nozzle;

FIG. 2 depicts a photograph of the cross section of the jet nozzle;

FIG. 3 depicts the results of elemental analysis of a poor wetting area;

FIG. 4 depicts a photograph of the cross section of a jet nozzle;

FIG. 5 depicts the results of elemental analysis of solder from a solder jet;

FIG. 6 is a schematic diagram of a soldering apparatus according to one aspect used for soldering;

FIG. 7 is a schematic diagram of the soldering apparatus in FIG. 6 above which a printed circuit board is placed;

FIG. 8 is a schematic diagram of the soldering apparatus in which gas is being sprayed on the outer side surface of the jet nozzle when ejection of a solder jet is stopped; and

FIG. 9 depicts an example graph indicating the relationship between the gas spray time and the jet nozzle temperature.

### DESCRIPTION OF EMBODIMENTS

[Soldering Method, Soldering Apparatus, and Method for Maintaining Solder Wetting of Jet Nozzle]

A soldering method disclosed herein is a soldering method in which soldering is performed on a workpiece by intermittently ejecting a solder jet from a jet nozzle.

A soldering apparatus disclosed herein is a soldering apparatus used to perform soldering on a workpiece.

A method for maintaining solder wetting of a jet nozzle disclosed herein is used in the soldering method in which soldering is performed on a workpiece by intermittently ejecting a solder jet from a jet nozzle.

Examples of the workpiece include printed circuit boards.

In the soldering method, gas is sprayed on the outer side surface of the jet nozzle when ejection of the solder jet from the jet nozzle is stopped.

The soldering method can be performed with, for example, the soldering apparatus.

The soldering apparatus includes, for example, an ejection unit and a gas spray unit and further includes other units, such as a synchronization unit, as desired.

The soldering method, the soldering apparatus, and the method for maintaining solder wetting of a jet nozzle will be described below.

In addition, the structure of the soldering apparatus will be also described together with the soldering method and the method for maintaining solder wetting of a jet nozzle.

In the soldering method in which soldering is performed on a workpiece by intermittently ejecting a solder jet from a jet nozzle, repeated soldering without cleaning the jet nozzle causes an oxide layer to form on the outer side surface of the jet nozzle. The solder jet on the surface of the oxide layer has poor wettability. The solder jet on the outer side surface of the jet nozzle becomes an uneven shape accordingly.

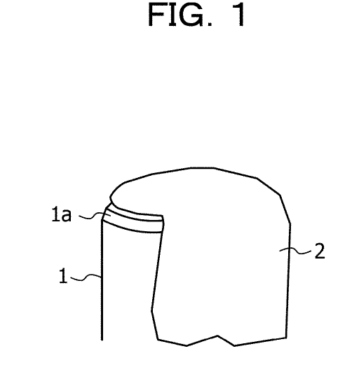

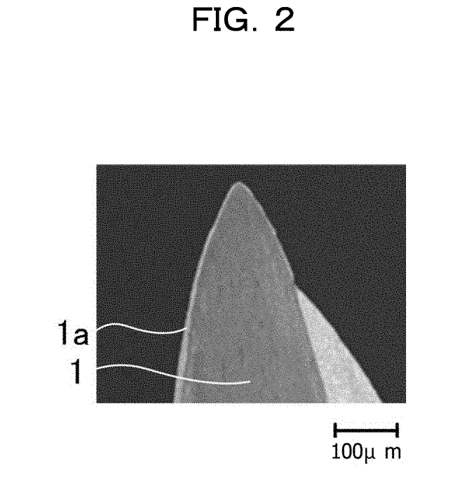

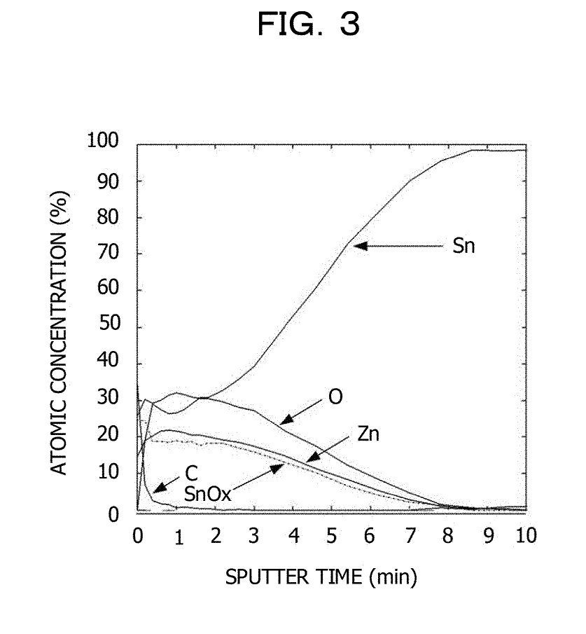

Here, a description is given to the photograph of the cross section of the jet nozzle (FIG. 2) with poor wetting on the outer side surface of the jet nozzle (FIG. 1) and to the results of elemental analysis in this case (FIG. 3).

As depicted in FIG. 1, a solder jet 2 fails to flow and has an uneven shape in a poor wetting area la on the outer side surface of a jet nozzle 1.

As depicted in FIG. 2, a thin film is formed in the poor wetting area la. As depicted in FIG. 3, the thin film is composed mainly of tin oxide (SnOx). Here, SnAgCu solder is used as solder. The elemental analysis is conducted by X-ray fluorescence spectrometry.

In the poor wetting area 1a, poor wetting occurs when ejection is restarted after ejection of the solder jet has stopped. The solder jet does not flow in this area.

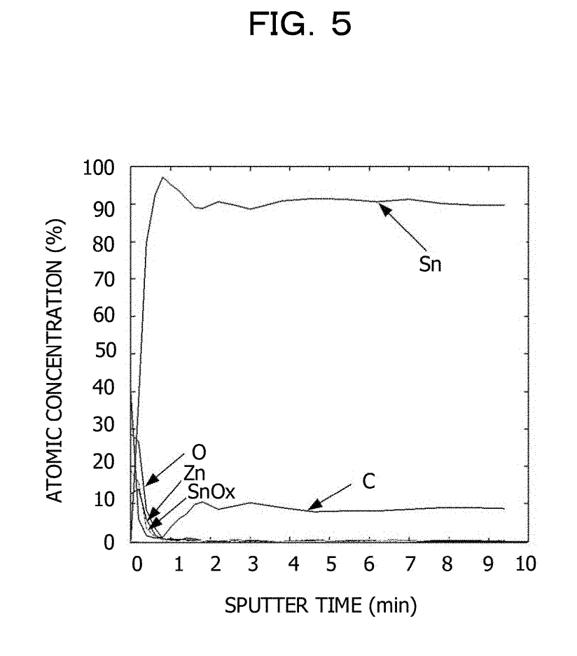

In FIG. 3 and FIG. 5, a sputter time of 1 minute corresponds to a sputtering thickness of about 5.1 nm.

In the disclosed technique, formation of a poor wetting area on the outer side surface of the jet nozzle can be reduced by spraying gas on the outer side surface of the jet nozzle when stopping ejection of the solder jet from the jet nozzle. The reason for this is as described below.

By spraying gas on the outer side surface of the jet nozzle when stopping ejection of the solder jet from the jet nozzle, the solder jet is cooled down on the outer side surface of the jet nozzle, and the solder from the solder jet is attached to the outer side surface of the jet nozzle. Restarting ejection of the solder jet causes the solder attached to the outer side surface of the jet nozzle to flow down together with the solder jet. Even if the oxide is formed on the surface of the solder attached to the outer side surface of the jet nozzle, the oxide flows down together with the solder and thus has no effect on poor wetting.

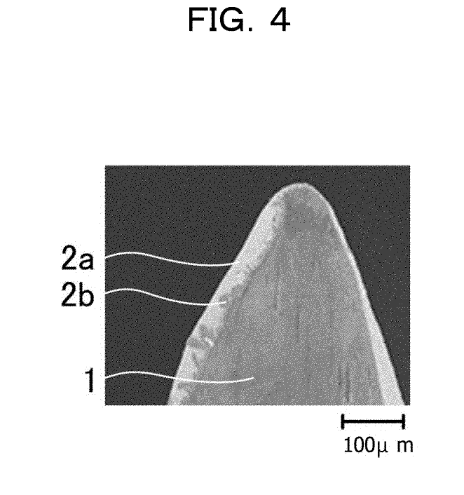

Here, a description is given to the photograph of the cross section of the jet nozzle (FIG. 4) in the case of spraying gas on the outer side surface of the jet nozzle when stopping ejection of the solder jet from the jet nozzle, and to the results of elemental analysis in this case (FIG. 5).

The photograph of the cross section in FIG. 4 and the results of elemental analysis in FIG. 5 indicate that a thick film of solder 2a from the solder jet is formed on the outer side surface of a jet nozzle 1 (made of steel). Furthermore, an alloy 2b (FeSn₂) formed from the solder jet and the jet nozzle is also formed in the solder 2a. An oxide (SnOx) is found only on the surface of the film.

The solder attached to the outer side surface of the jet nozzle protects the outer side surface of the jet nozzle and maintains the wettability of the outer side surface of the jet nozzle with respect to the solder jet.

Starting ejection of the solder jet causes the solder attached to the outer side surface of the jet nozzle to flow down together with the solder jet. At this time, the alloy is present. In the case where the alloy has a melting point lower than the temperature of the solder jet, starting ejection of the solder jet causes the alloy to melt early. As a result, the solder attached to the outer side surface of the jet nozzle flows down easily.

[Ejection Unit]

The ejection unit is any unit that has a jet nozzle and intermittently ejects a solder jet from the jet nozzle. The ejection unit is not limited and can be appropriately selected according to the intended purpose.

The ejection unit has, for example, the jet nozzle, a solder bath, and a solder flow feeder.

Solder for the solder jet is not limited and can be appropriately selected according to the intended purpose. Examples of solder include Sn and Sn alloys containing at least one metal selected from a group consisting of Ag, Bi, Cu, Ge, Ga, In, Sb, Ni, Zn, Pb, and Au.

Specific examples include Sn—Bi solder, Sn—In solder, Sn—Cu solder, Sn—Zn solder, Sn—Ag solder, Sn—Au solder, Sn—Pb solder, Sn—Sb solder, Sn—Bi—Ag solder, Sn—Ag—Cu solder, Sn—Bi—Cu solder, Sn—Zn—Bi solder, Sn—Bi—In solder, Sn—Ag—In solder, Sn—Ag—In—Bi solder, Sn—Cu—Ni solder, Sn—Cu—Ni—Ge solder, and Sn—Ag—Cu—Ni—Ge solder.

Among these, Sn—Ag—Cu (e.g., Sn—3.0 Ag—0.5 Cu) solder and Sn—Ag (e.g., Sn—3.5 Ag) solder are preferred.

The jet nozzle is a small-bore nozzle for spot soldering on a workpiece.

The bore diameter of the jet nozzle is not limited and can be appropriately selected according to the intended purpose. The bore diameter of the jet nozzle is, for example, 10 mm the 20 mm. The bore of the jet nozzle is not limited to a circular shape and may have, for example, a rectangular shape.

The thickness of the outer side surface of the jet nozzle is not limited and can be appropriately selected according to the intended purpose. Too large a thickness may result in a low cooling efficiency during the spraying of the gas. Too small a thickness may result in erosion by solder, which may cause formation of a hole. The thickness is preferably 0.1 mm to 1.0 mm, and more preferably 0.3 mm to 0.7 mm.

The material of the jet nozzle is not limited and can be appropriately selected according to the intended purpose. Examples of the material include steel.

The solder bath is any bath that stores molten solder. The size, material, shape, and structure of the solder bath are not limited and can be appropriately selected according to the intended purpose.

The solder flow feeder is a member that forms molten solder in the solder bath and feeds the molten solder to the jet nozzle. The solder flow feeder includes, for example, a heater that heats a solder material placed in the solder bath to form molten solder, a heater that heats the jet nozzle, a pump that forms a solder flow of the molten solder, and a solder flow path through which the molten solder in the form of a solder flow is fed to the jet nozzle. The temperature control of the heater and the drive control of the pump are conducted by, for example, a controller.

The pump in the solder flow feeder may be replaced by a compressor that pressure-feeds gas to the solder bath. A solder flow of the molten solder can be formed by pressure-feeding gas to the solder bath using the compressor.

The temperature of the jet nozzle during ejection of a solder jet from the jet nozzle is not limited and can be appropriately selected according to the intended purpose. In view of the fluidity of the solder jet, the temperature of the jet nozzle is preferably higher than the melting point of the solder by 50° C. or more, and more preferably by 75° C. or more. When the temperature of the jet nozzle is too high, many restrictions are imposed on facility. Therefore, the temperature of the jet nozzle is preferably higher than the melting point of the solder by 50° C. or more and 200° C. or less, and more preferably by 75° C. or more and 150° C. or less.

The ejection time per single solder jet and the ejection stop time for intermittent ejection of the solder jet from the jet nozzle are not limited and can be appropriately selected according to the intended purpose.

[Gas Spray Unit]

The gas spray unit is any unit that sprays gas on the outer side surface of the jet nozzle. The gas spray unit is not limited and can be appropriately selected according to the intended purpose. The gas spray unit has, for example, a gas spray nozzle from which gas is sprayed, and a compressor that produces compressed gas.

The type of gas is not limited and can be appropriately selected according to the intended purpose. Examples of gas include atmosphere and inert gas.

The amount of gas sprayed is not limited and can be appropriately selected according to the intended purpose. The amount of gas sprayed is, for example, from 10 L/min to 100 L/min.

The temperature of the gas is not limited and can be appropriately selected according to the intended purpose. Since the gas is neither cold air nor hot air, the temperature of the gas is preferably 10° C. to 50° C. and more preferably 20° C. to 40° C. to save energy for cooling or heating the gas.

During the spraying of the gas on the outer side surface of the jet nozzle, the temperature of the jet nozzle is preferably lowered by 50° C. or more, more preferably lowered by 75° C. or more, and still more preferably lowered by 100° C. or more. The temperature of the jet nozzle is not lowered to room temperature. In this respect, the temperature of the jet nozzle is preferably lowered by 50° C. or more and 250° C. or less, more preferably 75° C. or more and 200° C. or less, and still more preferably by 100° C. or more and 150° C. or less.

From a different viewpoint, during the spraying of the gas on the outer side surface of the jet nozzle, the temperature of the jet nozzle is preferably lowered to a temperature equal to or lower than the melting point of the solder, and more preferably lowered to a temperature equal to or lower than the melting point of the alloy.

The distance between the outer side surface of the jet nozzle and the tip of the gas spray nozzle from which the gas is sprayed is not limited and can be appropriately selected according to the intended purpose. The distance is preferably 50 mm to 1,000 mm, more preferably 100 mm to 700 mm, and still more preferably 200 mm to 500 mm. When the distance is too short, the gas hits the jet nozzle too strongly, so that a film of the solder may not be formed on the outer side surface of the jet nozzle. When the distance is too long, the efficiency for cooling the jet nozzle may be low.

The thickness of the film of the solder attached to the outer side surface of the jet nozzle is not limited and can be appropriately selected according to the intended purpose. The thickness of the film is preferably 10 μm to 100 μm, and more preferably 20 μm to 70 μm.

By spraying gas on the outer side surface of the jet nozzle when stopping ejection of the solder jet from the jet nozzle, the solder from the solder jet is attached to the outer side surface of the jet nozzle. Starting ejection of the solder jet causes the solder to flow down together with the solder jet.

The solder attached to the outer side surface of the jet nozzle protects the outer side surface of the jet nozzle and maintains the wettability of the outer side surface of the jet nozzle with respect to the solder jet.

Furthermore, an alloy formed from the solder jet and the jet nozzle is preferably formed on the outer side surface of the jet nozzle. The melting point of the alloy is preferably lower than the temperature of the solder jet. With such a melting point, starting ejection of the solder jet causes the alloy to melt early. As a result, the solder attached to the outer side surface of the jet nozzle flows down easily.

In view of cooling efficiency and uniform cooling, the gas is preferably sprayed from two or more positions and preferably sprayed from two opposite positions across the jet nozzle.

When the gas is sprayed from two opposite positions across the jet nozzle, two spray nozzles are disposed opposite each other across the jet nozzle.

[Synchronization Unit]

The spraying of the gas is preferably synchronized with the stopping of the solder jet. This ensures that the solder is attached to the outer side surface of the jet nozzle.

The synchronization is performed by, for example, the synchronization unit.

The synchronization unit is any unit that synchronizes the stopping of the solder jet with the spraying of the gas. The synchronization unit is not limited and can be appropriately selected according to the intended purpose. Examples of the synchronization unit include a controller. The controller serving as the synchronization unit instructs the gas spray unit to spray the gas when instructing the ejection unit to stop the solder jet.

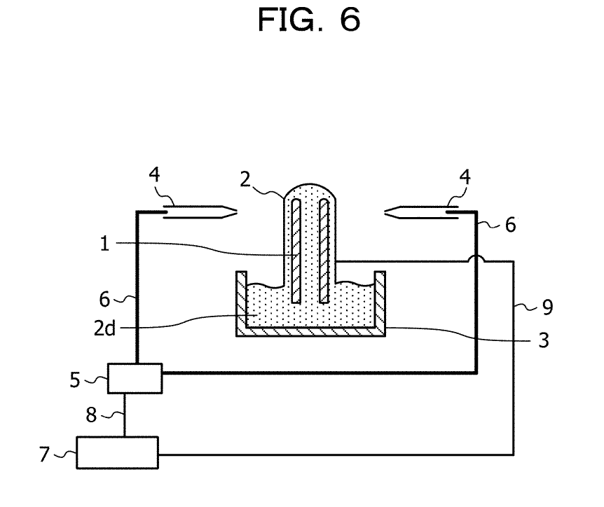

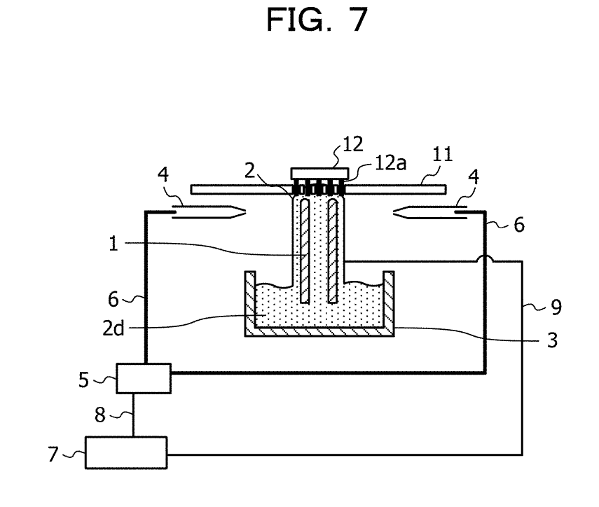

Referring to FIG. 6 and FIG. 7, the soldering method, the soldering apparatus, and the method for maintaining solder wetting of a jet nozzle will be described as examples.

FIG. 6 is a schematic diagram of a soldering apparatus according to one aspect used for soldering.

FIG. 7 is a schematic diagram of the soldering apparatus in FIG. 6 above which a printed circuit board is placed.

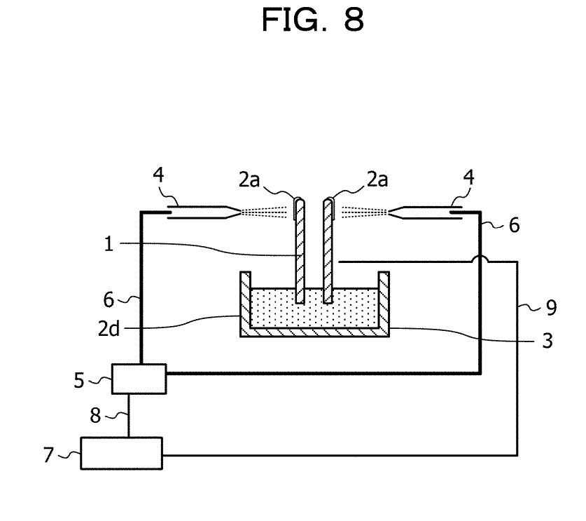

FIG. 8 is a schematic diagram of the soldering apparatus in which gas is being sprayed on the outer side surface of the jet nozzle when ejection of a solder jet is stopped.

In this aspect, pins 12a of an electronic component 12 are soldered to through-holes of a printed circuit board 11.

The soldering apparatus depicted in FIG. 6 to FIG. 8 has an ejection unit, a gas spray unit, and a controller 7.

The ejection unit has a jet nozzle 1, a solder bath 3, and a pump (not illustrated).

The gas spray unit has two gas spray nozzles 4, a compressor 5, and gas piping 6. Two gas spray nozzles 4 oppose each other across the jet nozzle 1.

The compressor 5 is connected to the controller 7 via wiring 8, and production of compressed gas by the compressor 5 is controlled by the controller 7.

The pump (not illustrated) is connected to the controller 7 via wiring 9, and operation of the pump is controlled by the controller 7.

In soldering using the soldering apparatus, the solder in the solder bath 3 is first heated with a heater (not illustrated) to form molten solder 2d. The molten solder 2d in the solder bath 3 is fed to the jet nozzle 1 by the pump (not illustrated). The molten solder 2d fed to the jet nozzle 1 is ejected as a solder jet 2 from the tip of the jet nozzle 1 (FIG. 6).

During ejection of the solder jet 2 from the jet nozzle 1, the printed circuit board 11 having through-holes is scanned over the solder jet 2. The pins 12a of the electronic component 12 have been inserted in the through-holes. The pins 12a are soldered to the through-holes by bringing the pins 12a in the through-holes into contact with the solder jet 2 ejected from the tip of the jet nozzle 1 (FIG. 7). The scanning may be performed by moving the ejection unit or may be performed by moving the printed circuit board.

When wetting on the outer side surface of the jet nozzle 1 is poor and the solder jet 2 ejected from the jet nozzle 1 has an even shape here, the solder is attached to other components and a short circuit occurs between pins due to a failure of drawing of solder.

In the disclosed soldering method, as depicted in FIG. 8, gas is sprayed on the outer side surface of the jet nozzle 1 when ejection of the solder jet 2 is stopped. The gas is sprayed as follows: feeding compressed gas produced by the compressor 5 to the gas spray nozzles 4 through the gas piping 6; and spraying the compressed gas from the gas spray nozzles 4 toward the outer side surface of the jet nozzle 1. The solder jet is cooled down accordingly, and the solder 2a is attached to the outer side surface of the jet nozzle 1.

In this process, the solder 2a can assuredly be attached to the outer side surface of the jet nozzle 1 by synchronizing the stopping of ejection of the solder jet 2 with the spraying of the gas using the controller 7.

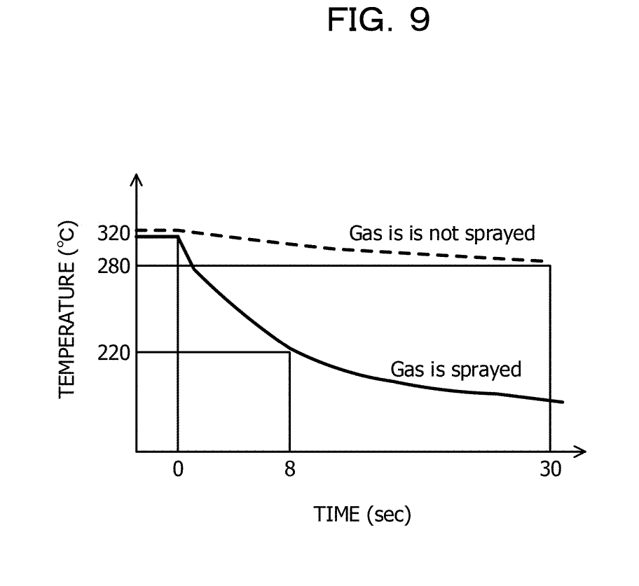

FIG. 9 depicts the results indicating the relationship between the gas spray time and the jet nozzle temperature. The conditions are as described below. The solder jet at 320° C. is ejected from the jet nozzle. As depicted in FIG. 8, upon the stopping of ejection of the solder jet 2, gas (room temperature) at 70 L/m is sprayed on the solder jet from positions opposite each other across the jet nozzle. The temperature of the jet nozzle is measured at a position 5 mm below from the tip of the jet nozzle. The gas spray nozzles are 300 mm distant from the outer side surface of the jet nozzle.

As depicted in FIG. 9, in the case where no gas is sprayed, the temperature of the jet nozzle decreases very slowly and the temperature of the jet nozzle is about 280° C. even about 30 seconds after the solder jet has stopped. In the case where gas is sprayed, the temperature of the jet nozzle decreases by 100° C. after 8 seconds. That is, the spraying of the gas on the jet nozzle lowers the temperature of the outer side surface of the jet nozzle. The spraying of the gas thus cools the solder jet flowing down along the outer side surface after ejection of the solder jet has stopped. As a result, the solder is attached to the outer side surface of the jet nozzle. This solder reduces poor wetting on the outer side surface of the jet nozzle.

The studies by the inventors suggest that, for example, in the case where no gas is sprayed, 100 times of intermittent jets cause poor wetting on the outer side surface of the jet nozzle. In the case where gas is sprayed, 500 times of intermittent jets cause no poor wetting on the outer side surface of the jet nozzle.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A soldering method comprising:
intermittently ejecting a solder jet to a workpiece from a jet nozzle; and
spraying gas on an outer side surface of the jet nozzle when stopping ejection of the solder jet from the jet nozzle.

2. The soldering method according to claim 1,
wherein solder from the solder jet is attached to the outer side surface of the jet nozzle by spraying gas on the outer side surface of the jet nozzle when stopping ejection of the solder jet from the jet nozzle.

3. The soldering method according to claim 1,
wherein solder from the solder jet and an alloy formed from the solder jet and the jet nozzle are attached to the outer side surface of the jet nozzle by spraying gas on the outer side surface of the jet nozzle when stopping ejection of the solder jet from the jet nozzle.

4. The soldering method according to claim 3,
wherein the alloy has a melting point lower than a temperature of the solder jet.

5. The soldering method according to claim 1,
wherein the spraying of gas is synchronized with the stopping of the solder jet.

6. The soldering method according to claim 1,
wherein the spraying of gas is performed from two or more positions.

7. The soldering method according to claim 1,
wherein the spraying of gas is performed from two positions opposite each other across the jet nozzle.

8. The soldering method according to claim 1,
wherein the spraying of gas lowers a temperature of the jet nozzle to a temperature equal to or lower than a melting point of solder of the solder jet.

9. The soldering method according to claim 3,
wherein the spraying of gas lowers a temperature of the jet nozzle to a temperature equal to or lower than a melting point of the alloy.

10. The soldering method according to claim 1,
wherein the jet nozzle is made of steel.

11. The soldering method according to claim 1,
wherein solder of the solder jet is Sn—Ag—Cu solder.

12. The soldering method according to claim 3,
wherein the jet nozzle is made of steel,
the solder of the solder jet is Sn—Ag—Cu solder, and
the alloy is SnFe₂.

13. A soldering apparatus comprising:
a first nozzle from which a solder jet is intermittently ejected to a workpiece; and
a second nozzle from which gas is sprayed on an outer side surface of the first nozzle.

14. The soldering apparatus according to claim 13, further comprising:
a controller that performs control such that the gas is sprayed from the second nozzle upon stopping of the solder jet from the first nozzle.

15. The soldering apparatus according to claim 13,
wherein the second nozzle is one of two or more second nozzles from which gas is sprayed.

16. The soldering apparatus according to claim 13, further comprising:
a third nozzle from which the gas is sprayed,
wherein the second nozzle and the third nozzle are disposed opposite each other across the first nozzle.

17. A method for maintaining solder wetting of a jet nozzle, the method being used in a soldering method in which soldering is performed on a workpiece by intermittently ejecting a solder jet from the jet nozzle, the method comprising:
spraying gas on an outer side surface of the jet nozzle when stopping ejection of the solder jet from the jet nozzle.

18. The method for maintaining solder wetting of a jet nozzle according to claim 17,
wherein solder from the solder jet is attached to the outer side surface of the jet nozzle by spraying gas on the outer side surface of the jet nozzle when stopping ejection of the solder jet from the jet nozzle.

19. The method for maintaining solder wetting of a jet nozzle according to claim 17,
wherein solder from the solder jet and an alloy formed from the solder jet and the jet nozzle are attached to the outer side surface of the jet nozzle by spraying gas on the outer side surface of the jet nozzle when stopping ejection of the solder jet from the jet nozzle.

20. The method for maintaining solder wetting of a jet nozzle according to claim 19,
wherein the alloy has a melting point lower than a temperature of the solder jet.
